(19) United States
(12) Patent Application Publication
(10) Pub. No.: US 2001/0044310 A1
(43) Pub. Date: Nov. 22, 2001

(54) USER-SPECIFIC LOCATION INFORMATION

(76) Inventor: SCOTT LINCKE, SAN CARLOS, CA (US)

Correspondence Address: WILSON SONSINI GOODRICH & ROSATI, 650 PAGE MILL ROAD, PALO ALTO, CA, 943041050

(21) Appl. No.: 09/087,355

(22) Filed: May 29, 1998

(51) Int. Cl. H04Q 7/20

(52) U.S. Cl. 455/456; 455/457

(57) ABSTRACT

A method and a system for accessing location-dependent web content by a wireless communication device are provided. The location of the wireless communication device is derived from the identification of the base station receiving the wireless signal from the communication device. This location information can then be used to access the location-dependent web content.

### BACKGROUND OF THE INVENTION

This application relates to, and incorporates by reference, the United States patent application entitled “Method and Apparatus for Communicating Information over Low Bandwidth Communication Networks,” Ser. No. ______, filed ______, having inventors Jeffery C. Hawkins, Joeseph Sipher, and Scott D. Lincke.

### BACKGROUND OF THE INVENTION

1. Field of the Invention

The present invention relates in general to accessing location-dependent information available on Internet web sites by a wireless hand-held computer.

2. Description of Related Art

Location information can be useful in a variety of ways, as in navigation, establishing property boundaries, etc. Several systems exist for providing such information; the most widely-used is the constellation of satellites commonly known as the Global Positioning System (GPS). The GPS satellite system consists of twenty-four satellites broadcasting radio navigation signals. The GPS land-based control segment tracks the satellites and uploads orbital information and clocks corrections at all times. The satellite receivers determine time and position with a process that starts with measuring the time of arrival of the satellite signals. Time and position are calculated using the time of arrival data, the receiver's known position, the satellites' positions and current time, and a model of the transmission path characteristics.

Although GPS is designed to provide precise location information, the Department of Defense only releases a degraded GPS system for non-military use because of national security reasons. This reduced service, called the “Standard Positioning Service,” can be accessed through commercially available GPS receivers. Unfortunately, the GPS receiver is an expensive piece of equipment. This is true with other general time difference of arrival location systems such as the Loran or NAVSTAR, both of which require receivers and transmitting stations. The sophisticated receiving equipment adds cost and weight for adopting these systems for ordinary consumer needs.

Attempts have also been made to provide positioning information of mobile units in the wireless communication systems. For example, U.S. Pat. No. 4,054,880 (Dalabakis et al.) and U.S. Pat. No. 3,889,264 (Fletcher) disclose a “delta-position” system which uses three spectrally spaced-apart radio signals to track down the position of a vehicle carrying mobile receivers. U.S. Pat. No. 5,570,412 (LeBlanc) describes a system and method for updating a location databank used in a wireless communication system to generate scaled contour shapes having minimum and maximum boundaries, the intersection of which provides a bounding polygon area corresponding to the location of a mobile unit.

All of the above systems strive to provide precise location information. However, precise locations are not always necessary. For instance, while it is necessary to have the precise location of an injured person so medical assistance can be delivered promptly, only approximate location is needed for information relating to recreational activities. A user who is looking for a restaurant or a theater would most likely be willing to drive a few miles away from the his/her current location to reach the desired destination; therefore all establishments within a geographical zone would be of interest. Many Internet web sites providing location-related information only require approximate location information. For example, the web site MapQuest only needs location indicators as broad as a postal zip code to generate information about points of interest within the zone. Therefore, usefulness of approximate location information increases as the number of such web sites increases.

Positioning systems and Internet web servers providing location-dependent information exist separately. There is a need for a system to connect a mobile unit and the Internet together to bring the user a variety of location-dependent information available through the Internet. What is desired is an improved way of accessing location-related web content.

### SUMMARY OF THE INVENTION

This invention offers an inexpensive way for a hand-held computer to access location-related web content by using the location of a base station in wireless communication with the hand-held computer making a request. More particularly, the invention relates to a system and a method for converting the identification information of the base station in communication with the hand-held computer into location information such as a postal code, longitude, latitude, or the like; such location information can be used to access additional information available on Internet web servers.

One aspect of the invention uses a wireless communication system. The wireless communication system several components: a hand-held computer serving as a wireless communication device, a base station, and a server. The wireless communication system supports applications which are closely related to Internet sites furnishing location-related information. After an application is launched on the wireless communication device, a query is sent to the nearby base station. Each base station in the network is associated with a geographical zone, and each is responsive to queries submitted by subscriber devices with the zone. Each base station also has identification information which can be converted into location information such as a postal code, longitude, latitude, or the like.

When the wireless communication device communicates with a base station, the communication device can retrieve the identification information of the base station. The query and location information will be delivered from the wireless communication device to a server via the base station. The server will convert the query and location information into a standard Internet format and retrieves requested information from an appropriate web site. The retrieved information will be converted into a compressed format by the server and returned to the wireless communication device via the same route, but in reverse.

### BRIEF DESCRIPTION OF THE FIGURES

The invention is illustrated by way of example, and not limitation, in the figures. These and other features and advantages of the invention will become more apparent from the following detailed description in conjunction with the appended drawings in which:

FIG. 1 is a schematic diagram of the communication route between a wireless communication device and an Internet content provider.

FIG. 2 is the flow chart of the communication process sending queries from a wireless communication device to the Internet and getting responses from the Internet back to the wireless communication device.

FIG. 3 is a sample application launcher page.

FIG. 4 is a sample query page for food services as it appears on the wireless communication device.

FIG. 5 is a base station ID/postal code look-up table typical of a wireless data network.

FIG. 6 is a sample response page as it appears on the wireless communication device.

### DETAILED DESCRIPTION

A detailed description of a method and apparatus for transmitting a query, which contains the approximate location of the wireless communication device, to the Internet is provided with reference to the figures.

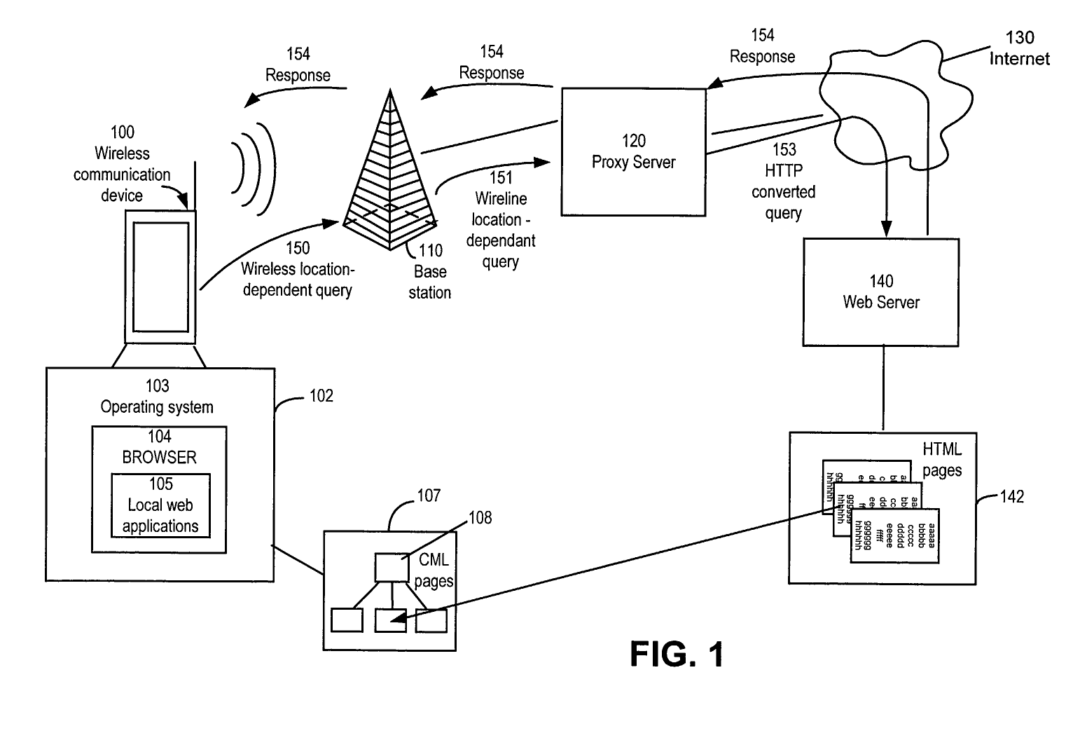

FIG. 1 illustrates a system view of one embodiment of the invention. The system includes the following main elements: a wireless communication device 100, a base station 110 in a network of base stations, a proxy server 120, and a web server 140. The wireless communication device 100 has a processor 102 which supports an operating system 103, a browser 104, and a plurality of local web applications 105. Each local web application includes a collection of Compact Markup Language (CML, a compressed language used to transfer Hypertext Markup Language screen contents from the proxy server 120 to the wireless communication device 100) pages 107. Each local web application is closely associated with an web site. Each local web application has mostly the static data for the web site. The first page that is displayed on the screen of the wireless communication device 100 after an application is launched is the query form 108.

The wireless communication device 100 is in wireless communication with the base station 110. Each base station 110 has a unique identification which can be converted into a postal code that represents a post office in close proximity to the base station and the user. When the antenna of the device 100 is raised, the device 100 transmits the location-specific query 150 and receives a response 154 to and from the base station 110. In a preferred embodiment, the base station 110 is part of a network of base stations under the Bell South West Wireless Date (BSWD) Mobitex Network. Each base station 110 in this network is equipped with anywhere from one to sixteen channels, but most have two or three channels. Base station channels are full duplex, capable of receiving and transmitting at the same time. Transmission frequencies are in the range of 896-901 MHz band and reception frequencies are in the range of 935-940 MHz band.

On the other hand, the base station 110, the proxy server 120, and the web server 140 are in wireline electronic communication.

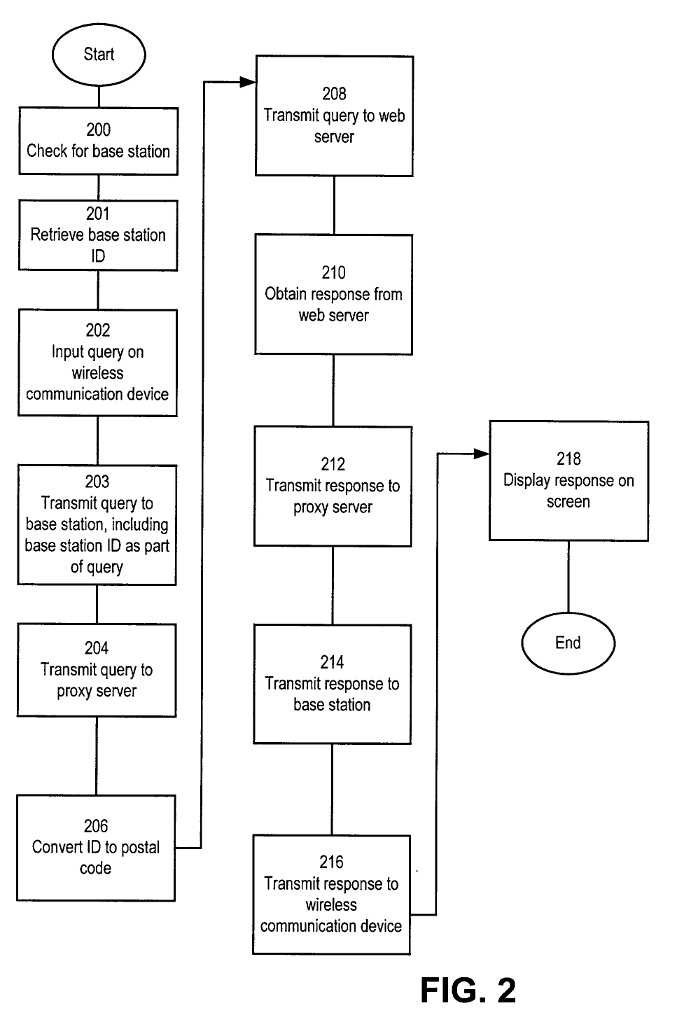

The communication process is documented step-by-step in a flow chart form in FIG. 2. This process can be implemented using the system of FIG. 1.

As Box 200 indicates, the wireless communication device checks for a base station as soon as the antenna is raised. The wireless communication device then retrieves the base station identification from the base station under Box 201.

Box 202 shows the step in which the user fills out a query form 108 on the communication device 100.

Once the query form 108 is completed, the query can be sent. Box 203 points to the step in which wireless query 150, including the base station identification, is transmitted to the base station 110.

Box 204 illustrates the step in which the query is transmitted from the base station to the proxy server 120.

In some embodiments, the proxy server 120 will convert the base station identification information into location information, as shown in Box 206. Alternatively, the base station 110 can do the conversion from the identification information to a postal code and incorporate the postal code into the wireless query 150. In other embodiments of the invention, the base station 110 can forward the information to the wireless communication device 100 and have the identification information converted and incorporated into query 150 by the wireless device 100.

Box 208 shows that the proxy server 120 communicates with the web server 140 using standard Internet protocols, such as HTTP. The proxy server 120 converts the wireline location dependent query 151 into a standard Internet format query 153.

Upon receiving the query 153, the web server 140 will retrieve the requested information from among the HTML pages 142 located in server 140, as shown in Box 210. The HTML pages 142 can be dynamically generated by programs running on the web server 140.

The response 154 will be transmitted back to the proxy server 120 as shown in Box 212.

The proxy server 120 will transmit the response 154 to the base station 110, shown in Box 214.

Finally, the response 154 will be received by the wireless communication device 100, and displayed on the screen of the device (Box 216, Box 218).

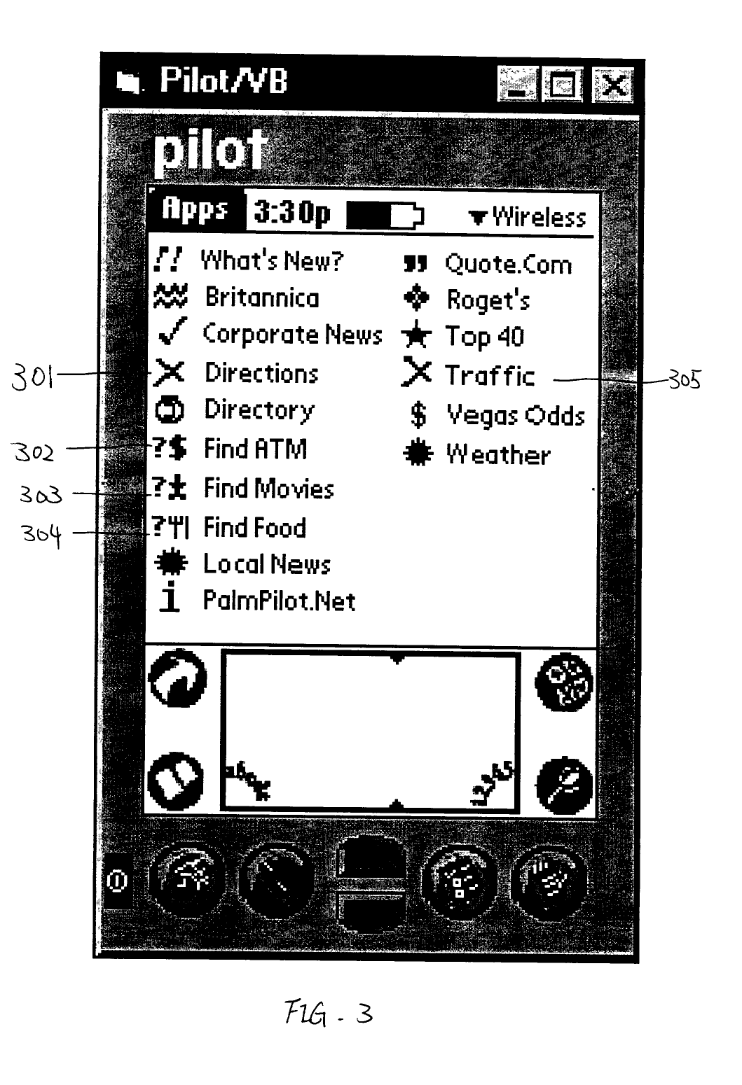

More specific details of the communication steps will be explained in the following paragraphs. Before initiating communication with the wireless network, the user of the wireless device first launches a local web application selected from the applications menu shown in FIG. 3. The local applications 107 available in FIG. 3 include location-dependent services such as Directions 301, Find ATM 302, Find Movies 303, Find Food 304, and Traffic 305. The web applications residing on wireless communication device 100 have corresponding Internet web sites residing on web servers. The local web applications can be an abridged version of the Internet web sites; however, they are content-rich, containing mostly static data. The static data does change frequently on the Internet web sites. The local web applications give users an opportunity to review data before making a wireless query. Because the wireless communication device 100 has a limited screen size, the local web contents are rendered in CML, the compressed form of HTML, rather than in HTML, which is normally used for Internet web sites.

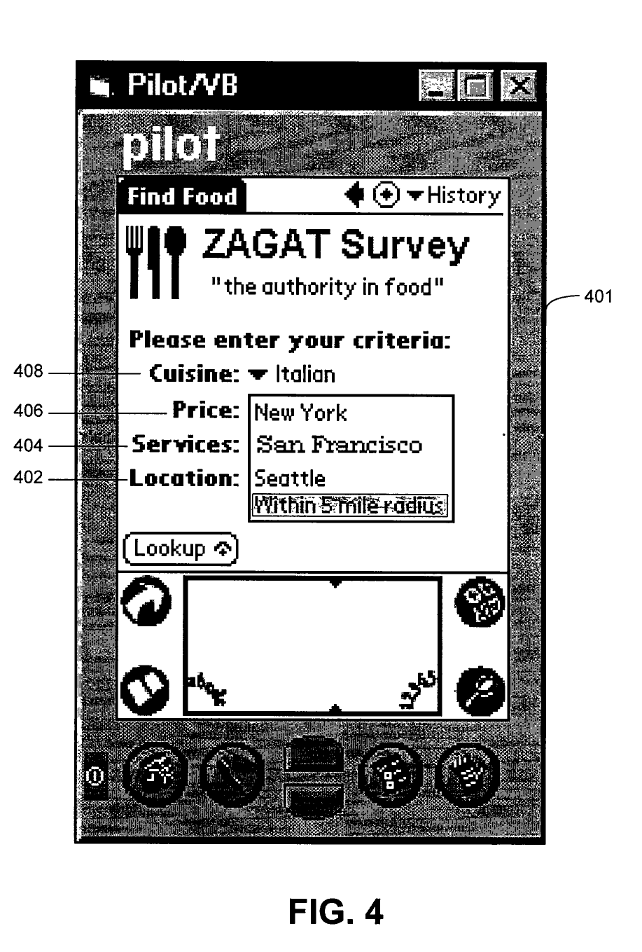

The first page that the user sees after launching an application is the query form. The completed query form provides the content of the query 150. FIG. 4 shows query a form 401 for the local web application Find Food 304. In general, query forms contain a list of input fields, and the user can input information through a number of input devices including radio buttons, text entry fields, and check boxes, etc. In order to save wireless network bandwidth, as little input as possible is required for transmission. Instead, the proxy server 120 will combine user input and other known information. The proxy server 120 converts the base station identification information to location information conversion, before submitting the query to the web server 140.

As an illustration, the query form 401 has four fields for user input: the field 408 for the type of cuisine, the field 406 for desired price, the field 404 for type of services, and the field 402 for location. FIG. 4 shows the field 402 offering a pop-up menu for the user to choose a location either by the name of the city (New York, San Francisco, Seattle), or by distance (within 5 mile radius of the current position). This last choice requires location dependent information. For this last selection, the query form 401 also contains a hidden field for postal code which does not require user input; this field instead will be completed by the proxy server 120 by converting the identification information of the base station 110 into a postal code that represents a post office near the base station 110.

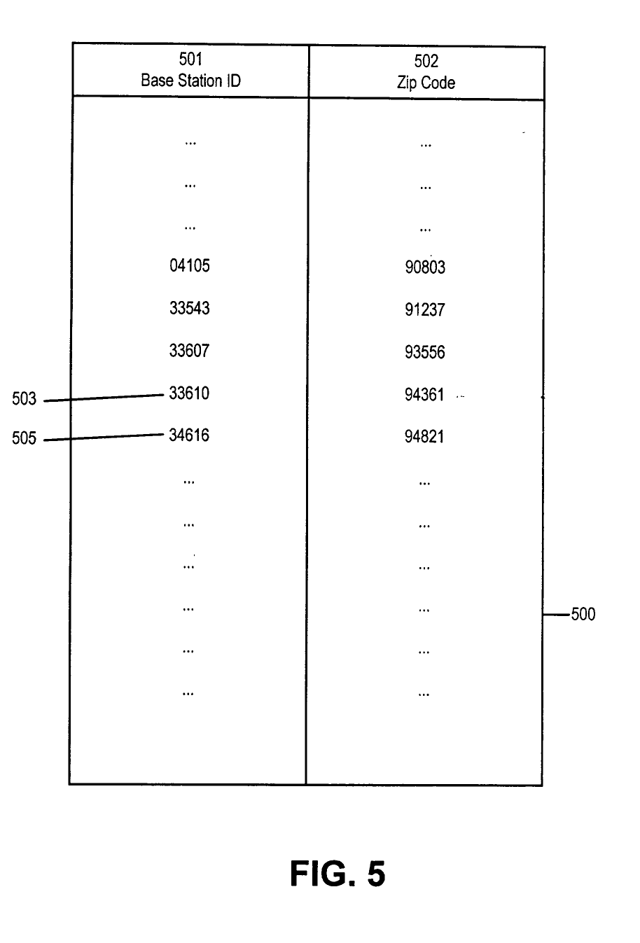

The conversion process comprises looking up in a table, such as table 500 shown in FIG. 5. Table 500 has two columns, a column 501 for base station ID, and a column 502 for postal code. Each row of Table 500 lists a base station identification number, and its corresponding postal code. For example, for row 503, the base station ID 33610 will be converted into a postal code 94361. Similarly, for row 505, the base station ID 34616 will be converted into a postal code 94821. In alternative embodiment of the invention, the table 500 can be stored in the wireless communication device 100, which can do the conversion. In another embodiment of the invention, the base station 110 will handle the conversion from the base station identification to a postal code.

The proxy server software 120 is responsible for responding to the wireline location dependent query 151, converting the query 151, which is in a compressed format suitable for low-bandwidth wireless transmission, into the query 153, which is in Internet standard format. The proxy server 120 will the transmit query 153 to the web server 140, and will receive the response 154 from the web server 140.

In a preferred embodiment, the proxy server 120 supports standard Internet protocol such as HTTP, SMTP, POP, and security protocols such as SSL, S-HTTP. Therefore, it is compatible with most HTML servers accessible through the Internet. On the other hand, because of the low bandwidth and limited power of the wireless communication device 100, the proxy server 120 converts the response 154 into UDP protocol, which is used for wireless communication. In order to further minimize the number of bytes required to send web content to a client, the proxy server 120 uses the compact format CML to transfer screen contents from the web server 140 to the base station 110. In the preferred embodiment, proxy server 120 can run on multiple machines simultaneously in order to adequately service simultaneous requests from many users; proxy server 120 also have stateless design, which is more tolerant of communication and protocol errors.

Finally, a web server 140 supports a web site accessible through the Internet 130. The web site hosts a collection of HTML pages 142, and the web site provides dynamic information not available to the user in the corresponding application stored locally on the wireless communication device 100. The web server 140 receives the HTML converted query 153, which includes the postal code (or other location identifying information), and retrieves the requested information from the collection of the HTML pages 142. The proxy server 120 accesses the content using HTTP.

The response 154 will be returned to the communication device 100 via the same route, in reverse order, that the query came from. The response 154 will first be transmitted to the proxy server 120 for format conversion into a CML format and then transmitted to the base station 110 using UDP/MPAK protocol. Base station 110 then returns response 154 to the wireless communication device 100 wirelessly. The processor 102 of the wireless communication device 100 will display response 154 on the screen.

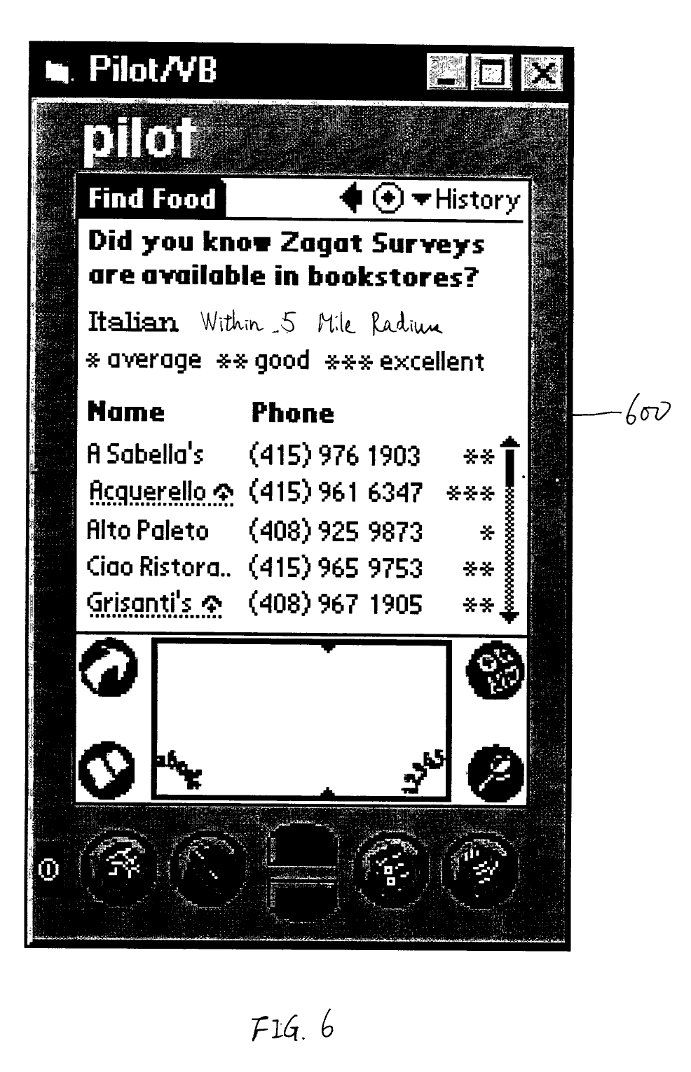

FIG. 6 is a sample response page 600 as it is displayed on the wireless screen of communication device 100. The response page 600 gives the user a list of Italian restaurants within approximately 5 miles radius of the base station which received the query form 401 of FIG. 4.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A communication system supporting communications between a wireless communication device and a server comprising:
a wireless communication device equipped for wireless communications, the wireless communication device having a processor for making a query and receiving a response, the query requesting location-dependent information;
a base station in a plurality of base stations, being equipped to be in wireless communication with the wireless communication device in a geographical zone, the base station having identification information associated thereto;
a server in electronic communication with the base station for processing the query, retrieving location-dependent information requested in the query wherein the location-dependent information is generated using the identification information of the base station, and transmitting said location-dependent information to said base station.

2. The communication system of claim 1, wherein the processor of the wireless communication device support a plurality of applications corresponding to Internet sites, wherein each application in the plurality of applications contains data available in the corresponding Internet site and each application provides user interface tools to access other data available in the corresponding Internet site.

3. The communication system of claim 2, wherein the application comprises a query form from which the query is derived.

4. The communication system of claim 1, wherein the wireless communication between the base station and the wireless communication device comprises base station receiving the query from the wireless communication device and base station transmitting the response to the wireless communication device.

5. The communication system of claim 1, wherein the processing by the server comprises converting the query from a compressed format to a standard Internet format, and converting the retrieved response from a standard Internet format to the compressed format.

6. The communication system of claim 1, wherein the processing by the server comprises converting the identification information to location information.

7. The communication system of claim 6, wherein the location information comprises a postal code.

8. The communication system of claim 6, wherein the location information comprises longitude and latitude.

9. The communication system of claim 1, wherein the base station converts the identification information to location information, forwards the query and the location information to the server, and receives the response from the server.

10. The communication system of claim 9, wherein the processing by the server comprises converting the query from a compressed format to a standard Internet format, and converting the retrieved response from a standard Internet format to the compressed format.

11. The communication system of claim 1, wherein the wireless communication between the base station and the wireless communication device comprises transmitting the identification information to the wireless communication device to be incorporated into the query by the wireless communication device, receiving the query having said identification information incorporated therein from the wireless communication device, and transmitting the response from the server to the wireless communication device.

12. The communication system of claim 11, wherein the processing by the server comprises converting the query from a compressed format to a standard Internet format, and converting the retrieved response from a standard Internet format to the compressed format.

13. A wireless communication device in communication with a base station located in a geographical zone, the base station having identification information associated therewith, comprising:
wireless communication capabilities for transmitting a query requesting location-dependent information to the base station;
a processor supporting a plurality of applications corresponding to Internet sites supplying location-dependent information, wherein each application in the plurality of applications contains data available in the corresponding Internet site and each application provides user interface tools to access other data available in the corresponding Internet site;
input devices to receive user input for the query;
a display screen for displaying a response containing the location-dependent information supplied by the Internet sites.

14. The wireless communication device of claim 13, wherein the query contains a field for indicating location information and wherein the field is filled in with location information derived from the identification information associated with the base station.

15. The wireless communication device of claim 14, wherein the location information is a postal code.

16. A server comprising software being responsive to a query requesting location-dependent information from a wireless communication device, converting the identification of a base station in communication with the wireless communication device to location information, retrieving location-dependent information from the Internet, transmitting location-dependent information to the wireless communication device.

17. The server in claim 16, wherein converting identification of the base station into location information comprises looking up in a table the postal code corresponding to the identification uniquely associated with the base station.

18. A method of generating a query seeking location-dependent information and receiving a response using a wireless communication device, the wireless communication device being in wireless communication with a base station, the base station monitoring the geographical zone in which the wireless communication device is located, the base station being in communication with a server, comprising:
communicating the query to the base station;
accessing location information of the base station;
forwarding the query and the base station location information to the server;
returning the response using the base station location information and the query; and
displaying of the response to the wireless communication device.

19. The method of claim 18, wherein the base station has identification information associated therewith.

20. The method of claim 19, wherein the accessing step comprises incorporating the identification information of the base station into the query.

21. The method of claim 20, wherein the server converts the base station identification information into a postal code.

22. The method of claim 18, wherein the generating step comprises the server generating the response by retrieving location-dependent information requested in the query from a web site and converting the location-dependent information into a compact format for transmission back to the wireless communication device.

23. A wireless communication device comprising:
a memory for storing programs and data; and
a processor for executing the programs and accessing the data, where the processor is coupled to the memory, where the processor is for sending a query to a wireless communications base station, wherein the query requires location information, wherein the location information corresponds to the approximate location of the wireless communication device, where the location information is determined by the location of the wireless communications base station, where the processor is for processing a received response, where the response is received in response to the query, and wherein the response includes information determined using the location information.

24. The wireless communication device of claim 23 wherein the query includes an identifier identifying the wireless communications base station, and wherein the location information is determined from the identifier.

25. The wireless communications device of claim 23 wherein the location information includes a postal code.

26. A method of accessing location dependent information using a handheld wireless communications device, the method comprising:
generating an information request, the information request requiring an approximate location of the handheld wireless communications device;
transmitting the information request to a base station;
determining the approximate location of the handheld wireless communications device from the location of the base station;
determining the location dependent information from the location of the base station; and
responding to the information request using the location dependent information.

27. The method of claim 26 wherein the base station is associated with a base station identifier, and wherein generating the information request includes inserting the base station identifier into the information request, and wherein determining the approximate location of the handheld wireless communications device includes using the base station identifier to determine the approximate location of the base station.

28. The method of claim 27 wherein the approximate location of the base station is defined by the postal code corresponding the base station.

29. The method of claim 27 wherein the approximate location of the base station is defined by the street address of the base station.

30. A wireless communication device comprising:
a first means for storing programs and data; and
a second means for executing the programs and accessing the data, where the second means is coupled to the first means, where the second means is for sending a query to a wireless communications base station, wherein the query requires location information, wherein the location information corresponds to the approximate location of the wireless communication device, where the location information is determined by the location of the wireless communications base station, where the second means is for processing a received response, where the response is received in response to the query, and wherein the response includes information determined using the location information.
